(19) United States
(12) Patent Application Publication
(10) Pub. No.: US 2014/0048621 A1
(43) Pub. Date: Feb. 20, 2014

(54) SUBSTANTIALLY CONCEALED IRRIGATION SYSTEM

(71) Applicants: William H. Burke, Henderson, NV (US); Melvin Scott McCombs, Henderson, NV (US); Rob Guy, Henderson, NV (US)

(72) Inventors: William H. Burke, Henderson, NV (US); Melvin Scott McCombs, Henderson, NV (US); Rob Guy, Henderson, NV (US)

(21) Appl. No.: 13/588,802

(22) Filed: Aug. 17, 2012

(51) Int. Cl. B05B 15/00; B29C 39/10; B32B 37/12; B23P 25/00

(52) U.S. Cl. 239/211; 29/527.1; 264/279; 156/305

(57) ABSTRACT

A water device comprising at least a water-carrying vessel and head, and a structure configured to blend in with a landscape environment wherein the structure conceals at least a portion of the water-carrying vessel while leaving the head exposed. Depending on the configuration, the structure may resemble a rock, bark, plant trunk, stone, bedding material, pavers, edge brick and similar decorative landscaping items and may be fabricated of resins, cements, epoxies, fillers, polymers, metals, recycled materials. Natural articles like stone and bark may also be used.

### FIELD OF THE INVENTION

The embodiments of the present invention relate to an irrigation system which can be concealed in the surrounding environment.

### BACKGROUND

Irrigation systems for residential and commercial properties are ubiquitous throughout the U.S. and many foreign jurisdictions. Such irrigation systems may include sprinklers, bubblers, drips and the like. While such irrigation systems are suitable for their intended purposes, they are often unsightly, broken and not directing water to the plant.

Thus, there exists a need for irrigation systems which are substantially concealable in their environmental surroundings, protected from breakage and directed to the subject plant.

### SUMMARY

Accordingly, a first embodiment of the present invention comprises a water device comprising at least a water-carrying vessel and head; and a structure configured to blend in with a landscape environment, said structure concealing at least a portion of said water-carrying vessel while leaving said head exposed. Depending on the embodiment, the structure may resemble a rock, bark, plant trunk, stone, bedding material and similar decorative landscaping items and may be fabricated of resin, stones, cements and fillers. Natural stone and bark may also be used.

In one embodiment, an irrigation device is fabricated by molding a structure around a portion of the water-carrying vessel. Alternatively, the structure may be formed with a channel configured to receive a portion of the water-carrying vessel.

Another embodiment of the present invention is a method comprising: molding a structure around a portion of a water-carrying vessel of a water device while leaving a water device head exposed, said structure configured to blend in with a landscape environment. Another embodiment of the present invention is a method comprising: molding a structure with a channel therethrough, said structure configured to blend in with a landscape environment; and inserting a water-carrying vessel of a water device in said channel while leaving a water device head exposed.

Other variations, embodiments and features of the present invention will become evident from the following detailed description, drawings and claims.

### BRIEF DESCRIPTION OF THE DRAWINGS

FIGS. 1a and 1b illustrate perspective views of bubblers of the type which may be used with the embodiments of the present invention;

FIG. 2 illustrates a block diagram of a conventional irrigation system of the type which may be used with the embodiments of the present invention;

FIG. 3a-3c illustrate bubblers according to the embodiments of the present invention;

FIGS. 4a and 4b illustrate a prior art bubbler installed in comparison to a bubbler installed according to the embodiments of the present invention;

FIG. 5 illustrates a first method of fabricating an irrigation device according to the embodiments of the embodiments of the present invention;

FIG. 6 illustrates a second method of fabricating an irrigation device according to the embodiments of the present invention; and

FIG. 7 illustrates a third method of fabricating an irrigation device according to the embodiments of the present invention

### DETAILED DESCRIPTION

It will be appreciated by those of ordinary skill in the art that the invention can be embodied in other specific forms without departing from the spirit or essential character thereof. The presently disclosed embodiments are therefore considered in all respects to be illustrative and not restrictive.

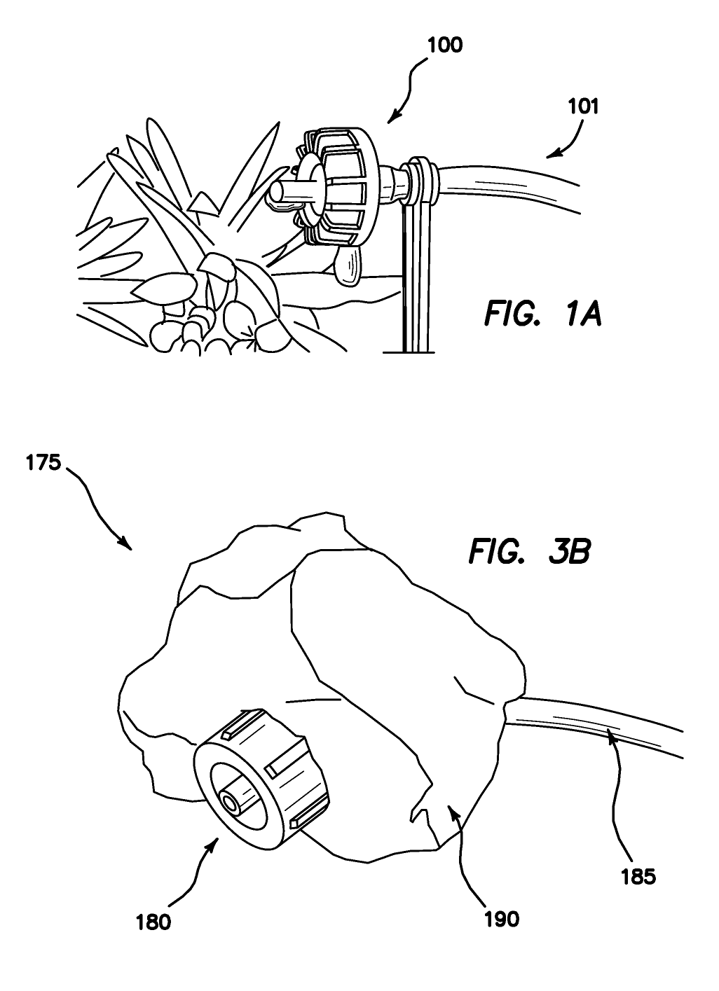

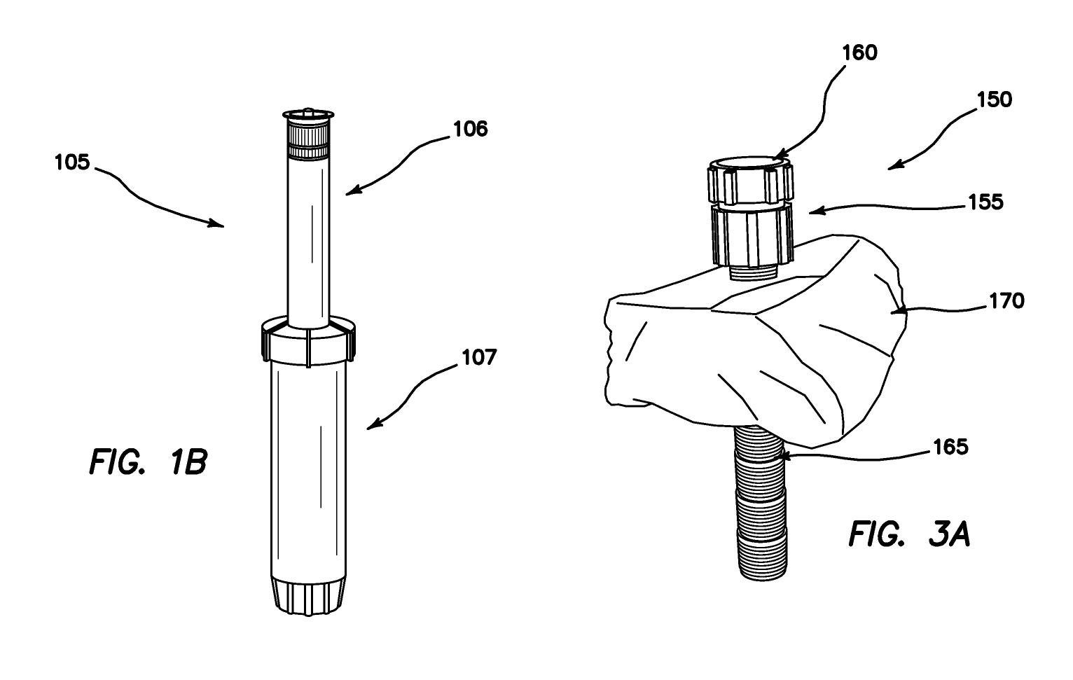

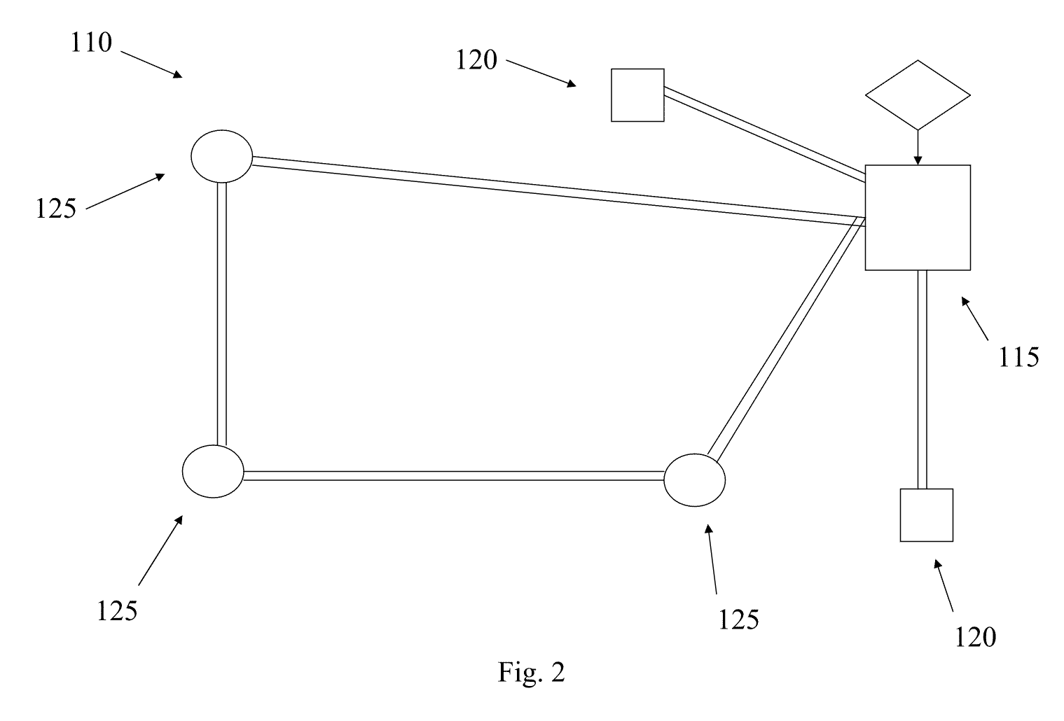

Initial reference is made to FIGS. 1a and 1b illustrating perspective views of a prior art bubbler 100 and pop-up sprinkler 105 of the type suitable for use with the embodiments of the present invention. Bubblers 100 are normally installed, along with flexible tubing 101, proximate to a plant or arrangement of plants and operate to dispense drops of water to keep the plant or plants hydrated. Pop-up sprinklers 105 are normally installed around edges of grass areas and aimed to pop-up and water the grass. When activated, a sprinkler mechanism 106 pops-up from a housing 107 and begins dispensing water. As shown in FIG. 2, a conventional irrigation system 110 comprises a water source 115 connected to bubblers 120, sprinklers 125 and the like, and a timer 130 which controls activation and de-activation of the irrigation system 110. Water flow control means may also be linked to the irrigation system 110. Tubing, piping, conduits and similar water-carrying vessels 135 link the water source to the bubblers 120 and sprinklers 125.

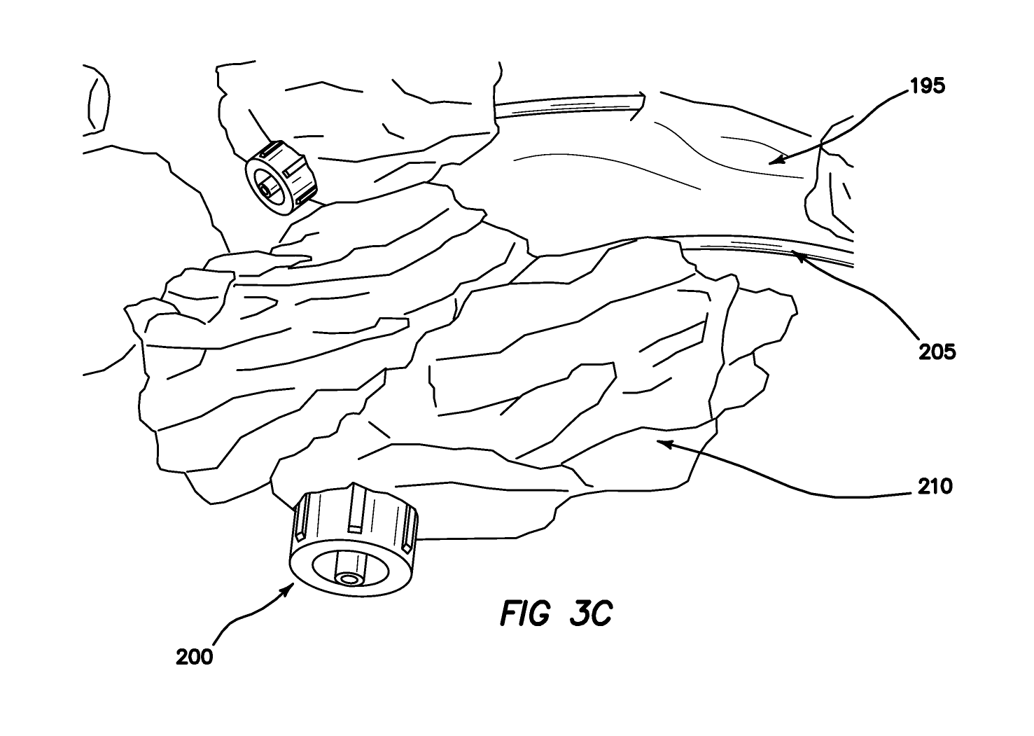

FIG. 3a shows a sprinkler 150 having a head 155, cap 160 and body 165 with a channel (i.e., water-carrying vessel) therethrough for carrying water to the head 155. A structure 170 in the form of a stone surrounds a portion of the body 165 and water-carrying channel therethrough. FIG. 3b shows a bubbler 175 having a head 180 and flexible tubing 185 for carrying water to the head 180. An arbitrarily-shaped structure 190 in the form of a stone surrounds a portion of the tubing 185. FIG. 3c shows a bubbler 195 having a head 200 and tubing 205 for carrying water to the head 195. A structure 210 in the form of bark surrounds a portion of the tubing 205. Other structures include brick pavers, edge bricks and similar structures. Alternatively, structures may be molded into decorative shapes such as animals, plants and similar shapes suitable for the environmental area in which the structure is to be placed. As shown in FIGS. 3a-3c, the structures 170, 190 and 210 are positioned proximate the heads 155, 180 and 195 and surround at least a portion of the water-carrying vessel of the bubbler or sprinkler By positioning the structures 170, 190 and 210 proximate the heads 155, 180 and 195 allows the devices to be substantially concealed in the landscape environment because the piping or tubing carrying water to the head 155, 180 and 195 is concealed by the structures 170, 190 and 210. Those skilled in the art will recognize that the structures 170, 190 and 210 may be positioned elsewhere as well.

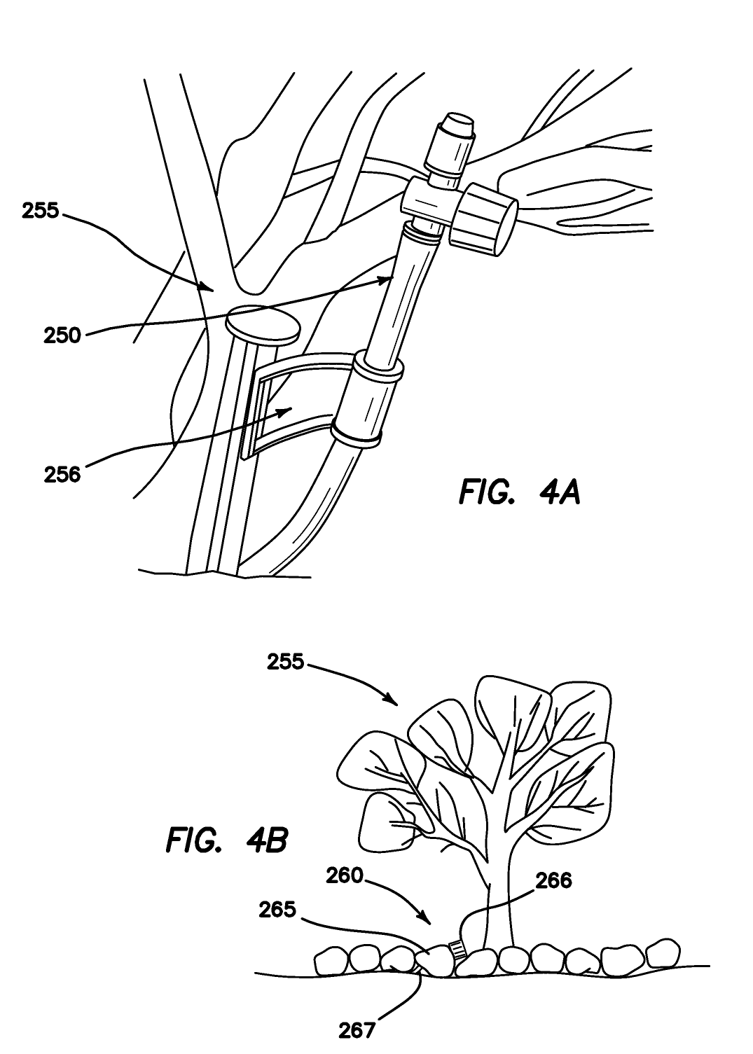

FIG. 4a shows a prior art bubbler 250 installed proximate a plant 255 using a spike 256 and FIG. 4b shows a bubbler 260 having a stone structure 265, head 266 and flexible tubing 267 installed proximate a plant. The stone structure 265 allows the bubbler 260 to blend in with the stones proximate the plant 255. The stone structure 265 also serves to protect the bubbler head 270 and maintain the direction of drip from the bubbler. That is, stone structure 265 acts to maintain a position of the bubbler 260 against the impact of the environment such as the rain and wind and other forces.

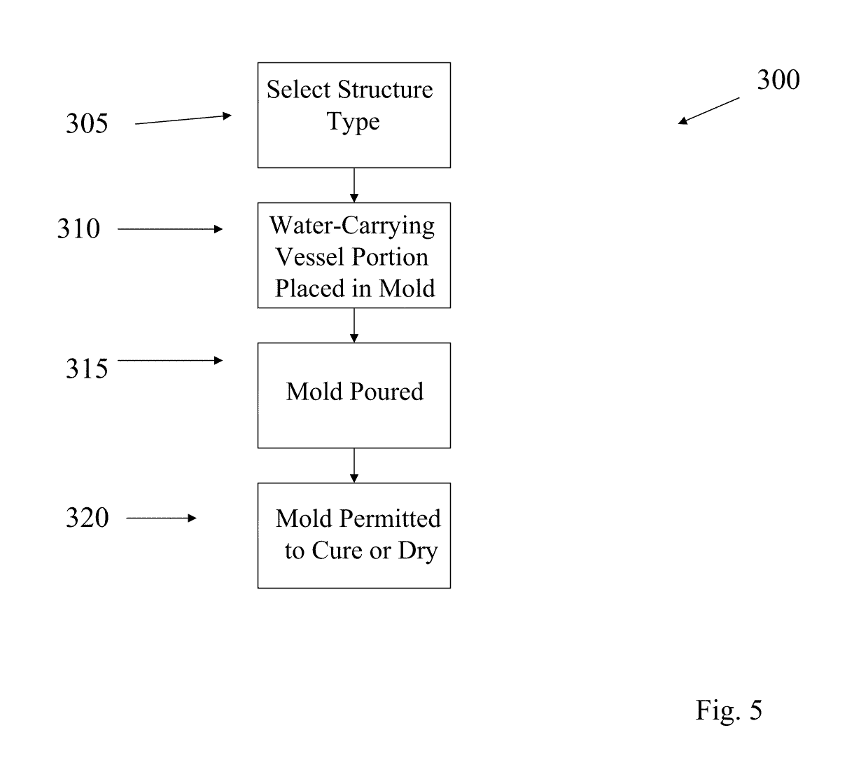

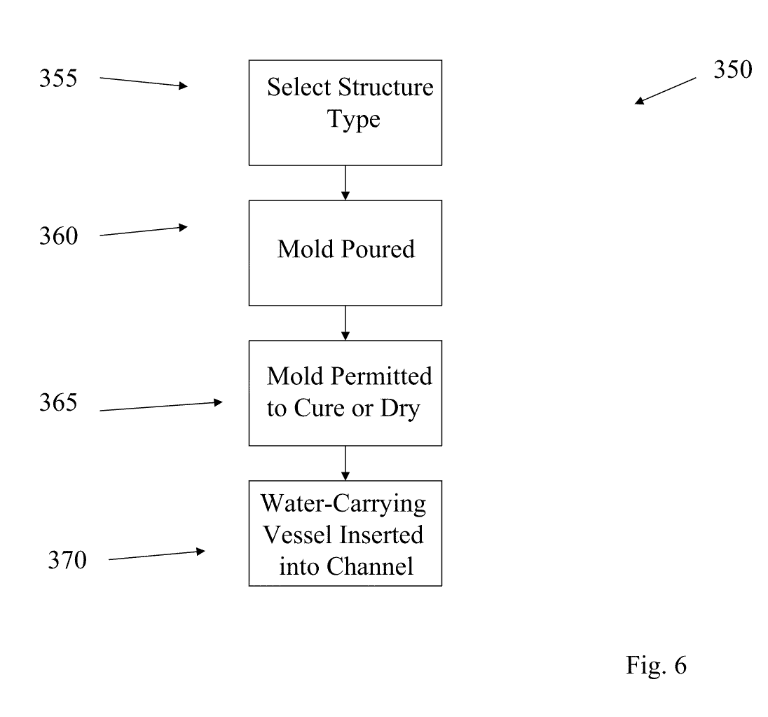

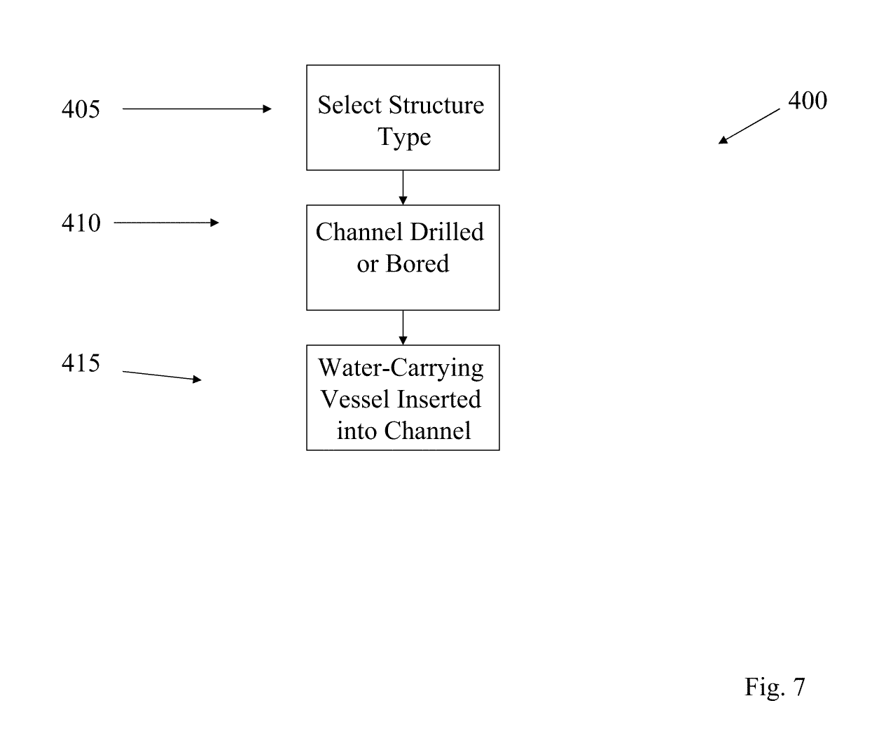

Fabricating the devices according to the embodiments of the present invention may take various forms as described relative to FIGS. 5, 6 and 7. A first fabrication method detailed in flow chart 300 of FIG. 5, involves a method of forming the structure around the water-carrying vessel (e.g., flexible tubing, piping, etc.). At 305, a structure type (e.g., stone, bark, etc.) is selected. At 310, the water-carrying portion of a water device is appropriately positioned in a structure mold. At 315, resins, cements, epoxies, fillers, polymers, metals, recycled materials (of the type disclosed in U.S. Pat. No. 8,092,593) and similar types of materials are poured into the mold to create the selected structure type. At 320, the molded structure is permitted to cure or dry with the water device molded therein forming a single unit. A second fabrication method detailed in flow chart 350 of FIG. 6. involves a method of forming the structure separately from the water device. At 355, a structure type (e.g., stone, bark, etc.) is selected. At 360, resins, cements, epoxies, fillers, polymers, metals, recycled materials and similar types of materials are poured into a mold having a channel therethrough to create the selected structure type. The channel dimensioned based on the water-carrying vessel to which is will be combined. At 365, the molded structure is permitted to cure or dry. At 370, the water-carrying vessel of the water device is inserted into the channel in the structure. The water-carrying vessel may be held in place within the structure channel via friction or a water proof adhesive. An alternative method is described in flow chart 400 of FIG. 7. At 405, the structure in the form of a natural stone or bark (or other article) is selected. At 410, a channel is drilled, bored or otherwise created in the structure. The channel dimensioned based on the water-carrying vessel to which is will be combined. At 415, a water-carrying vessel of a subject water device is inserted into the channel. The water-carrying vessel may be held in place within the structure channel via friction or a water proof adhesive.

The embodiments of the present invention may be used with static sprinklers, pop-up sprinklers, drips, drip lines, bubblers and similar water devices.

Although the invention has been described in detail with reference to several embodiments, additional variations and modifications exist within the scope and spirit of the invention as described and defined in the following claims.

We claim:

1. An apparatus comprising:
a water device comprising at least a water-carrying vessel and head in communication with a water source; and
a structure including a passageway receiving at least a portion of said water-carrying vessel while leaving said head exposed, said structure configured to blend in with a landscape environment.

2. The apparatus of claim 1 wherein said water device is selected from the group consisting of a sprinkler, drip and bubbler.

3. The apparatus of claim 1 wherein said structure is fabricated with the appearance of stone.

4. The apparatus of claim 1 wherein said structure is fabricate with the appearance of bark.

5. The apparatus of claim 1 wherein said water-carrying vessel is flexible tubing.

6. The apparatus of claim 1 wherein said water-carrying vessel is piping.

7. The apparatus of claim 1 wherein said structure is natural stone.

8. The apparatus of claim 1 wherein said structure is natural bark.

9. A method comprising:
molding a structure around a portion of a water-carrying vessel of a water device while leaving a water device head exposed, said structure configured to blend in with a landscape environment.

10. The method of claim 9 wherein said water-carrying vessel is flexible tubing.

11. The method of claim 9 wherein said water-carrying vessel is piping.

12. The method of claim 9 further comprising molding said structure with the appearance of stone.

13. The method of claim 9 further comprising molding said structure with the appearance of bark.

14. A method comprising:
molding a structure with a channel therethrough, said structure configured to blend in with a landscape environment; and
inserting a water-carrying vessel of a water device into said channel while leaving a water device head exposed.

15. The method of claim 14 wherein said water-carrying vessel is flexible tubing.

16. The method of claim 14 wherein said water-carrying vessel is piping.

17. The method of claim 14 further comprising molding said structure with the appearance of stone.

18. The method of claim 14 further comprising molding said structure with the appearance of bark.

19. The method of claim 14 further comprising applying a water proof adhesive to said channel.

20. A method comprising:
creating a channel through a structure configured to blend in with a landscape environment; and
inserting a water-carrying vessel of a water device into said channel while leaving a water device head exposed.

21. The method of claim 20 further comprising applying a water proof adhesive to said channel.
